(19) United States
(12) Patent Application Publication
(10) Pub. No.: US 2018/0328622 A1
(43) Pub. Date: Nov. 15, 2018

(54) ELECTRIC HEATING DEVICE

(71) Applicant: MAHLE International GmbH, Stuttgart (DE)

(72) Inventors: Falk VIEHRIG, Stuttgart (DE); Michael KOHL, Bietigheim-Bissingen (DE); Wolfgang SEEWALD, Tamm (DE); Konrad DUBIL, Karlsruhe (DE)

(73) Assignee: MAHLE International GmbH, Stuttgart (DE)

(21) Appl. No.: 15/975,020

(22) Filed: May 9, 2018

(30) Foreign Application Priority Data
May 12, 2017 (DE) 10 2017 208 086.8

(51) Int. Cl. F24H 3/04; F24H 9/18; B60H 1/22

(52) U.S. Cl. CPC F24H 3/0429; B60H 1/2225; F24H 9/1872

(57) ABSTRACT

An electrical heating element, in particular for a heating or air-conditioning system of a motor vehicle, having a heating block, which includes a plurality of electrical heating elements having heaters and having contacts, which electrically contact the heaters, the heating block including a plurality of radiator elements, which are thermally connected to the heaters for the purpose of transferring heat from the heaters to a medium flowing against the radiator elements, the heaters having two diametrically opposed, wide side surfaces and two diametrically opposed, narrow side surfaces. The contacts electrically contact the heaters on the diametrically opposed narrow side surfaces, or the contacts electrically contact the heaters on the diametrically opposed, wide side surfaces in diagonally opposite areas, viewed laterally, which are each adjacent to one of the diametrically opposed, narrow side surfaces.

This nonprovisional application claims priority under 35 U.S.C. § 119(a) to German Patent Application No. 10 2017 208 086.8, which was filed in Germany on May 12, 2017, and which is herein incorporated by reference.

### BACKGROUND OF THE INVENTION

### Field of the Invention

The present invention relates to an electrical heating device, in particular for heating an interior of a motor vehicle, which includes, in particular, an electric drive motor and/or an internal combustion engine, comprising a heating block which includes a plurality of heating elements having a heater and having a contact for electrically contacting the heater, the heating block furthermore including a plurality of radiator elements, which are arranged in thermal contact to the heating elements.

### Description of the Background Art

In the prior art, many different electrical heating devices have become known as electrical heaters or as block heaters, in particular for heating a vehicle interior. The electrical heater is used as a main heat source or as the only heat source, while the block heater represents an additional heat source, usually along with a heating element, through which a coolant flows, as the main heat source.

In summary, heaters and block heaters can therefore be referred to as electrical heating devices within the meaning of the present invention.

Electrical heating devices are used, for example, to heat an air flow, which is generated by a fan in a heating or air-conditioning system. Electrical heating devices of this type include a plurality of electrical heating elements, which have a heater, radiator elements being thermally connected to the heating elements to heat the air flow flowing against the radiator elements.

The heating elements are electrically contacted on both sides by a contact, which are designed as planar sheet metal strips and which electrically contact the entire side surface of the heater. An electrical contact over a wide area and a low transfer resistance are produced thereby, so that a uniform heating of the heater results. The heating up of the heater is controlled by controlling the electrical current flow through the heater.

Since the radiator elements thermally abut the heating elements or are in thermal contact therewith, the contact represent a thermal barrier, which must be crossed by the heat flow, starting from the heater, before the heat is able to reach the radiator element and be transferred to the inflowing air flow.

The documents EP 2 395 295 A1, EP 2 395 296 A1 and EP 2 397 788 A1 disclose electrical heating devices of this type, in which a contact is arranged as sheet metal strips between the heater and the radiator elements. The heat flow from the heater in the direction of the radiator element is hindered thereby, so that the heaters are heated up to a greater degree. If the heats are designed as PTC elements, this results in their heating power being reduced at a higher temperature.

Moreover, there is the problem that the vehicle electrical system voltage may be up to 800 V or higher, in particular in future electric vehicles, so that the electrical heating device would also be operated at such a high voltage.

However, today's heating elements, which have PTC elements as heaters, are not designed for such high voltages. At the high voltages, the sparkover protection is not ensured in the PTC elements currently being used, because the sheet metal strips as contacts are spaced relatively close together in the PTC elements currently being used. If the spacing is limited, the sparkover protection is inadequate at the high voltages. At the same time, however, the PTC elements cannot be arbitrarily made much thicker, because the heat decoupling suffers thereby based on the heat flow, due to the rather poor thermal conductivity of the material of the PTC elements, and the PTC element would continue to heat up unnecessarily and undesirably thereby, which would further reduce the heating power of the PTC element.

### SUMMARY OF THE INVENTION

It is therefore an object of the present invention to provide an electrical heating device, which is easy and cost-effective to manufacture, compared to the prior art, and which is nevertheless improved over the prior art.

An exemplary embodiment of the invention relates to an electrical heating device, in particular for a heating or air-conditioning system of a motor vehicle, comprising a heating block which includes a plurality of electrical heating elements having heaters and having contacts, which electrically contact the heaters, the heating block having a plurality of radiator elements, which are thermally connected to the heaters for the purpose of transferring heat from the heater to a medium flowing against the radiator elements, the heaters having two diametrically opposed, wide side surfaces and two diametrically opposed, narrow side surfaces, the contacts electrically contacting the heater on the diametrically opposed narrow side surfaces, or the contacts electrically contacting the heaters on the diametrically opposed, wide side surfaces in diagonally opposite areas, viewed laterally, which are each adjacent to one of the diametrically opposed, narrow side surfaces. This achieves the fact, on the one hand, that the contacts are situated at a greater distance from each other than the extension height of the narrow side surface, which reduces the risk of electrical sparkover, and, on the other hand, that the contacts do not induce any or almost no thermal resistance between the heaters and the radiator elements. An electrical heating device of this type may be generally used to heat air or another fluid, for example a liquid coolant of a coolant circuit.

According to an embodiment, it is also advantageous if the heaters are each electrically contacted by at least one contact on their two narrow side surfaces. The electrical contacting thus takes place according to the extension of the wide side surfaces at a distance from each other, so that the electrical sparkover is reduced or avoided, even at high voltages in the range of 800 V or even more.

It is also advantageous if the contacts are designed as electrically conductive, in particular metallic, profiles, which planarly abut the narrow side surfaces of the heater. The electrical contacts on the side surface are produced thereby, for the purpose of conducting the current through the heater. However, the heat is dissipated via the wide side surfaces, which permits a good heat decoupling, due to the narrow structure of the heater.

It is also advantageous if the contacts have at least one contact surface, which, in its extension height in parallel to the narrow side surface of a heater which it abuts, essentially has approximately the same or a shorter extension height than the contacted, narrow side surface of the heater. If the electrical contacting is approximately as wide as the narrow side surface of the heater, the narrow side surface may be approximately contacted over its entire area, which reduces the electrical transfer resistance.

According to an embodiment, it is also advantageous if the heaters are each electrically contacted by at least one contact in two diagonally opposite corner areas, in the area of the wide side surfaces. The contact is also situated thereby so far apart from each other that an electrical sparkover is avoided or its probability is significantly reduced. However, the areas provided for the thermal decoupling are not impaired all too much, so that a good heat transfer in the direction of the radiator element is achievable.

According to an embodiment, it is also advantageous if the contact is designed as electrically conductive, in particular metallic, profiles, which planarly abut the wide side surfaces of the heater in diagonally opposite areas, viewed laterally. A good electrical contact with the heater is achieved thereby, in particular if the electrical contact area is planar and, in particular occupies a planar portion which takes up approximately one fifth to one tenth or more of the wide side area of the heater.

It is also advantageous if the contacts are each disposed in a recess in a corner area of the heater. This achieves the fact that the contacts are fitted into the heater at least to the extent that they do not project too far thereover or not at all. An approximately smooth and/or level surface of the heater is achieved thereby due to the arrangement of the contact.

It is also advantageous if the distance between the contacts is greater than twice the extension of the heater on the narrow side surface. A great enough distance is selected thereby that an electric sparkover may be avoided or its probability is significantly reduced.

It is particularly preferred if the heater and/or the contacts are electrically insulated in the direction of the radiator elements with the aid of an electrical insulating element. A voltage-conducting element which is not electrically insulated is outwardly avoidable thereby, so that the risk of accidents may be reduced or avoided.

It is also advantageous if the arrangement of the heater and the contact of a heating element is covered or surrounded by at least one electrical insulating element and is electrically insulated. A voltage-conducting element which is not electrically insulated is outwardly avoidable thereby, so that the risk of accidents may be reduced or avoided.

According to an embodiment, it is also advantageous if the arrangement of the heater and the contact of a heating element is disposed in a tube element along with at least one electrical insulating element. The electrical heating device becomes particularly suitable for everyday use thereby, even for high mechanical requirements, because the accommodation within a tube is particularly stable and insensitive.

It is also advantageous if the particular radiator element rests on the outside of a tube. A particularly stable yet compact design is achievable thereby, a good heat transfer, and thus a high effectiveness, being achieved.

It is also advantageous if the electrical insulating element is made from a plastic material or from a ceramic material or from another material having a high thermal conductivity and good dielectric properties. A material of this type made can also be Kapton, aluminum nitrite. A long-lasting and reliable electrical insulation is achieved thereby.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective representation of an exemplary embodiment of an electrical heating device according to the present invention;

FIG. 2 shows a sectional representation of a detail of a heating element having radiator elements according to the conventional art;

FIG. 3 shows a sectional representation of a detail of a heating element having radiator elements according to the invention;

FIG. 4 shows a perspective representation of parts of the exemplary embodiment according to FIG. 3;

FIG. 5 shows a sectional representation of a heater having a contact according to FIGS. 3 and 4;

FIG. 6 shows a sectional representation of a detail of an alternative heating element having radiator elements according to the invention;

FIG. 7 shows a perspective representation of parts of the exemplary embodiment according to FIG. 5; and

FIG. 8 shows a sectional representation of a heater having a contact according to FIGS. 6 and 7.

### DETAILED DESCRIPTION

FIG. 1 shows a perspective representation of an exemplary embodiment of an electrical heating device 1 according to the invention, in which a heating block 2 is provided, in particular for heating air for a heating and/or air-conditioning device. Alternatively, electric heating device 1 may also be provided to heat another gas or a liquid fluid, for example a coolant or water, possibly with additives.

Heating block 2 has a plurality of heating elements 3 and a plurality of radiator elements 4. In the exemplary embodiment in FIG. 1, heating elements 3 are arranged so that they alternate with radiator elements 4 in a sandwich design, so that the air between heating elements 3 is able to flow past radiator elements 4; cf. arrow 5, which indicates the air flow. An effective heating of the air is achieved thereby. Other arrangements of heating elements 3 and radiator elements 4 are also possible, which provide a different sequence or a different spatial arrangement of heating elements and/or radiator elements. Other arrangements may also be provided for heating liquid media or fluids.

Heating elements 3 include a heater, to which an electrical current is applied and which therefore heat up. The heat is transferred via radiator elements 4 to air flow 5, which is heated thereby.

To impress the electrical current, a contact is applied to the heater and contact them, so that an electrical voltage is applicable, and the electric current may be impressed.

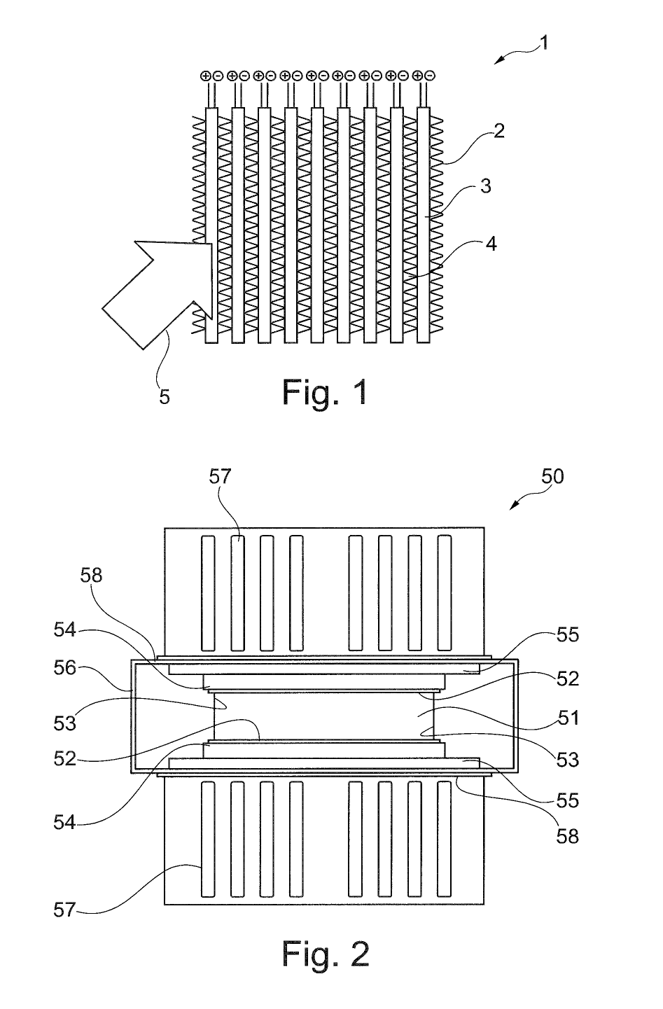

FIG. 2 shows a section of heating element 50 according to the conventional art. It is apparent that heating element 50 includes a heater 51, which has a cuboid design and is rectangular in section, including two diametrically opposed, wide side surfaces 52 and two diametrically opposed, narrow side surfaces 53. Sheet metal electrodes, which are in electrical contact with one or multiple heaters 51, abut both sides of wide side surfaces 52 as a contact 54. Contact 54 is covered with an insulating element 55 and electrically insulated on the side facing away from heater 51. Heater 51, contact 54 and insulating elements 55 are disposed together in a tube 56 surrounding them. A radiator element 57, which is in thermal contact with heater 51, is disposed on each side of tube 56, on its wide side surfaces 58. In particular, contact 54 is electrically connected to a voltage source via terminals to be able to impress an electric current through heater 51 for the purpose of heating them.

It is apparent in FIG. 2 that contact 54 abut wide side surfaces 52 of heater 51 over their entire area as planar sheet metal electrodes to ensure an electric contacting of heater 51. At the same time, heater 51 also transfer heat outwardly to radiator elements 57 via their wide side surface 52, so that contact 54 also act as heat resistors, which is generally viewed as disruptive.

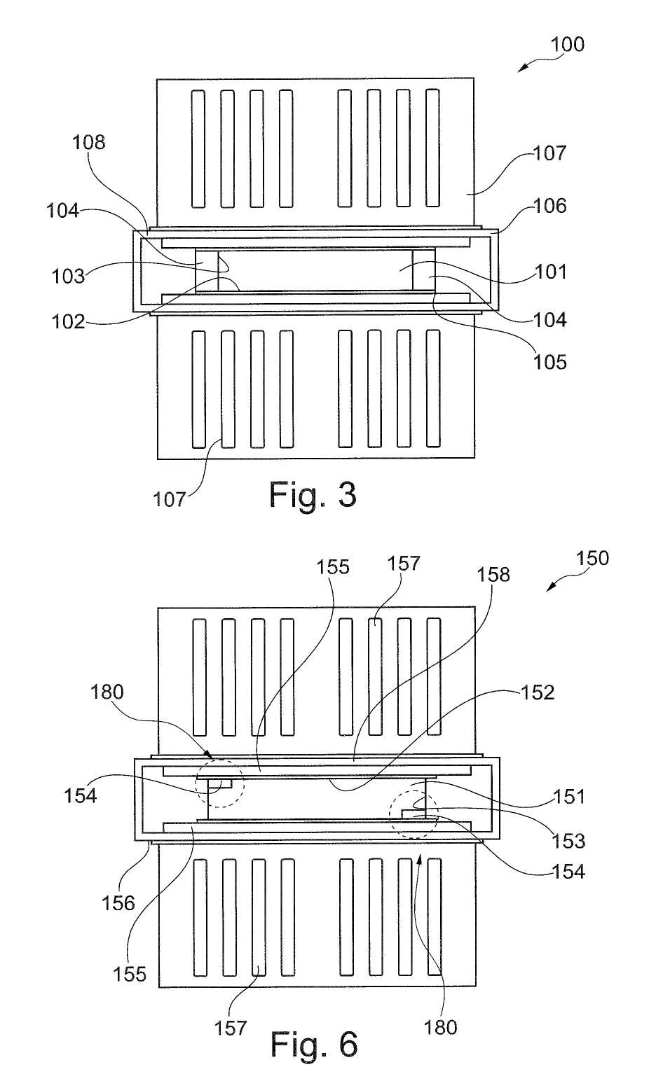

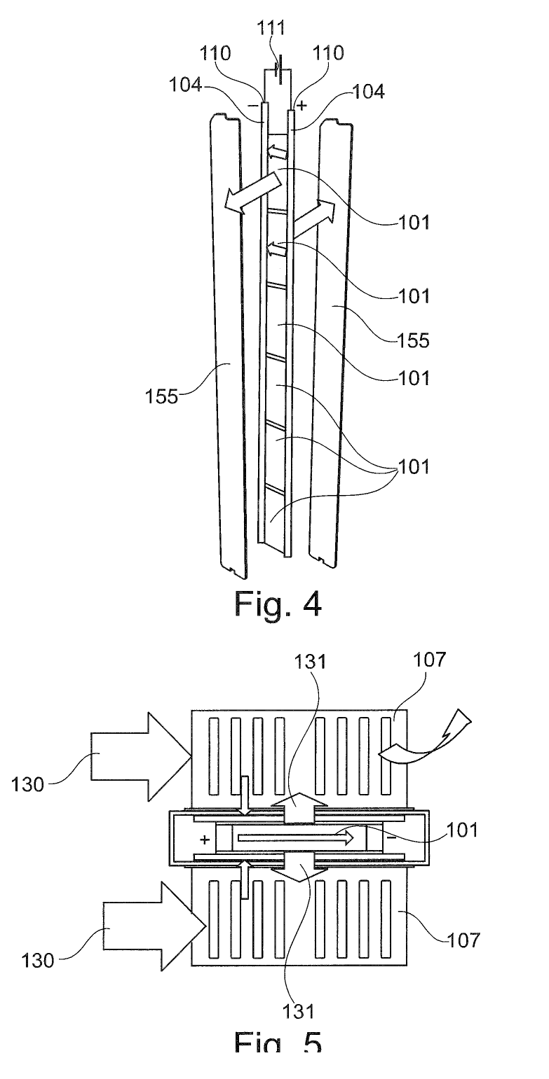

FIG. 3 shows a section of an exemplary embodiment according to the invention of a heating element 100 of an electrical heating device according to the invention. Heating element 100 includes at least one heater 101 and preferably a plurality of heats 101. Only the section of a heater 101 is apparent, it being readily possible to also provide multiple heaters 101 in the longitudinal direction of heating element 100, i.e. in the direction of the page plane; cf. FIG. 4, which shows the arrangement of a plurality of heaters 101 in a heating element 100. Heaters 101 are disposed adjacent to each other in a series.

It is apparent in FIGS. 3 and 4 that heating element 100 includes a heater 101, which have an essentially cuboid design and are essentially rectangular in section, including two diametrically opposed, wide side surfaces 102 and two diametrically opposed, narrow side surfaces 103. Profiles in the form of electrodes abut both sides of wide side surfaces 103 as a contact 104, which is in electrical contact with one or multiple heaters 101. Contact 104 is designed as electrically conductive profiles, in particular as metallic profiles. Contact 104 is designed, in particular, as rectangular profiles.

It is apparent in FIG. 3 that contact 104 has a rectangular design in section and abut narrow side surface 103 of heater 101 via one side surface.

Heater 101 and contact 104 are covered by an insulating element 105 and electrically insulated on the wide side surface of heater 101 and the adjacent side surface of contact 104. Heater 101, contact 104 and insulating elements 105 are disposed together in a tube 106 surrounding them. A radiator element 107, which is in thermal contact with heater 101, is disposed on each side of tube 106, on its wide side surfaces 108.

In particular, contact 104 is electrically connected to a voltage source 111 via terminals 110 illustrated in FIG. 4, to be able to impress an electric current through heater 101 for the purpose of heating them.

It is apparent in FIGS. 3 and 4 that contact 104 abuts narrow side surfaces 103 of heater 101 over its entire area as, for example, cuboid or rod-shaped electrodes to ensure an electric contacting of heater 101. At the same time, heater 101 also transfer the heat outwardly to radiator elements 107 via their wide side surface 102, so that contact 104 does not act as disruptive heat resistors.

FIG. 5 shows arrow 130 indicating the air flow of the air to be heated. According to arrow 131, heater 101 transfers the heat to radiator elements 107, which transfer the heat to the air.

FIGS. 1 and 3 through 5 show an electrical heating device, in particular for a heating or air-conditioning device of a motor vehicle, comprising a heating block which includes a plurality of electrical heating elements 100, having a heater 101 and a contact 104, which electrically contact heater 101. The heating block includes a plurality of radiator elements 107, which are thermally connected to heater 101 for the purpose of transferring heat from heater 101 to a medium flowing against radiator elements 107. Heater 101 has two diametrically opposed, wide side surfaces 102 and two diametrically opposed, narrow side surfaces 103. According to FIGS. 3 through 5, the contacts are designed in such a way that they electrically contact heater 101 on diametrically opposed, narrow side surfaces 103.

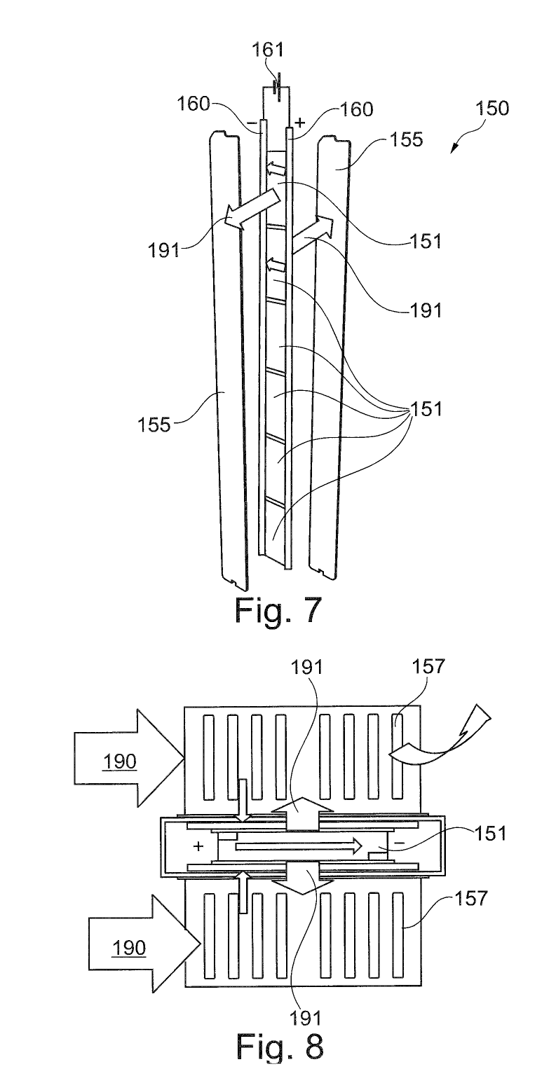

FIG. 6 shows a sectional view of an exemplary embodiment according to the invention of a heating element 150 of an electrical heating device according to the invention. Heating element 150 includes at least one heater 151 and preferably a plurality of heaters 151. Only the section of a heater 151 is apparent, it being readily possible to also provide multiple heaters 151 in the longitudinal direction of heating element 150, i.e. in the direction of the page plane; cf. FIG. 7, which shows the arrangement of a plurality of heater 151 in a heating element 150. Heater 151 is disposed adjacent to each other in a series.

It is apparent in FIGS. 6 and 7 that heating element 150 includes heater 151, which has an essentially cuboid design and is essentially rectangular in section, including two diametrically opposed, wide side surfaces 152 and two diametrically opposed, narrow side surfaces 153. Contact 154 contacts heater 151 on both sides on the wide side surfaces. Contact 154 electrically contacts heater 151 on diametrically opposed side surfaces 152 in diagonally opposite areas 180, viewed laterally, each of which is situated adjacent to one of diametrically opposed, narrow side surfaces 153. This achieves the fact that contact 154 is disposed only in the side areas of wide side surfaces 152 and only insignificantly impair the heat transfer between heater 151 and radiator elements 157.

Contact 154 is designed as, for example a flat, rectangular profile in section, which can be used as an electrode, which is in electrical contact with the one or multiple heaters 151. Contact 154 is designed as electrically conductive profiles, in particular as metallic profiles. Contact 154 is designed, for example, as a rectangular profile.

It is apparent in FIG. 6 that contact 154 has a rectangular design in section and abut wide side surface 152 of heater 151 via one side surface.

Heater 151 and contact 154 are covered by an insulating element 155 and electrically insulated on wide side surface 153 of heater 151 and the adjacent side surface of contact 154. Heater 151, contact 154 and insulating elements 155 are disposed together in a tube 156 surrounding them. A radiator element 157, which is in thermal contact with heater 151, is disposed on each side of tube 156, on its wide side surfaces 158.

In particular, contact 154 is electrically connected to a voltage source 161 via terminals 160 illustrated in FIG. 4, to be able to impress an electric current through heater 151 for the purpose of heating them.

It is apparent in FIGS. 6 and 7 that contact 154 abut the lateral areas of wide side surfaces 152 of heater 151 over their entire area as preferably cuboid or rod-shaped electrodes to ensure an electric contacting of heater 151. At the same time, heater 151 also transfer the heat outwardly to radiator elements 157 via their wide side surface 152, so that contact 154 does not act as disruptive heat resistors.

FIG. 8 shows arrow 190 indicating the air flow of the air to be heated. According to arrow 191, heater 151 transfers the heat to radiator elements 157, which transfer the heat to the air.

FIGS. 1 and 6 through 8 show an electrical heating device, in particular for a heating or air-conditioning device of a motor vehicle, comprising a heating block which includes a plurality of electrical heating elements 150, having a heater 151 and having a contact 154, which electrically contacts heater 151. The heating block includes a plurality of radiator elements 157, which are thermally connected to heater 151 for the purpose of transferring heat from heater 151 to a medium flowing against radiator elements 157. Heater 151 has two diametrically opposed, wide side surfaces 152 and two diametrically opposed, narrow side surfaces 153. According to FIGS. 6 through 8, the contact is designed and arranged in such a way that it electrically contacts heater 151 on diametrically opposed side surfaces 152 in diagonally opposite areas 180, viewed laterally, each of which is situated adjacent to one of diametrically opposed, narrow side surfaces 153.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electrical heating device for a heating or air-conditioning device of a motor vehicle, the heating device comprising:
a heating block that includes a plurality of electrical heating elements having at least one heater and at least one contact that electrically contact the heater; and
a plurality of radiator elements that are thermally connected to the heater for transferring heat from the heater to a medium flowing against the radiator elements, the heater having two diametrically opposed, wide side surfaces and two diametrically opposed, narrow side surfaces,
wherein the contact electrically contacts the heater on the diametrically opposed, narrow side surface or the contact electrically contacts the heater on the diametrically opposed, wide side surfaces in diagonally opposite areas, viewed laterally, each of which is adjacent to one of the diametrically opposed, narrow side surfaces.

2. The electrical heating device according to claim 1, wherein the heater is electrically contacted on two narrow side surfaces by the at least one contact.

3. The electrical heating device according to claim 1, wherein the contact is designed as electrically conductive, metallic, profile, which planarly abuts the narrow side surfaces of the heater.

4. The electrical heating device according to claim 1, wherein the contact has at least one contact surface, which, in its extension height in parallel to the narrow side surface of the heater which it abuts, essentially has approximately the same or a shorter extension height than the contacted, narrow side surface of the heater.

5. The electrical heating device according to claim 1, wherein the heater is electrically contacted by the at least one contact in two diagonally opposite corner areas in the area of the wide side surfaces.

6. The electrical heating device according to claim 1, wherein the contact is designed as electrically conductive, metallic, profiles, which planarly abut the wide side surfaces of the heater in diagonally opposite areas, viewed laterally.

7. The electrical heating device according to claim 1, wherein the contact is disposed in a recess in a corner area of the heater.

8. The electrical heating device according to claim 1, wherein the spacing between contacts is greater than twice the extension of the heater on the narrow side surface.

9. The electrical heating device according to claim 1, wherein the heater and/or the contact are electrically insulated in the direction of the radiator elements with the aid of an electrical insulating element.

10. The electrical heating device according to claim 1, wherein the arrangement of the heater and the contact of a heating element is covered or surrounded by at least one electrical insulating element and electrically insulated thereby.

11. The electrical heating device according to claim 1, wherein the arrangement of the heater and the contact of a heating element is disposed in a tube element together with at least one electrical insulating element.

12. The electrical heating device according to claim 11, wherein the radiator element rests on an outside of a tube.

13. The electrical heating device according to claim 9, wherein the electrical insulating element is made from a plastic material or from a ceramic material or from another material having a high thermal conductivity and good dielectric properties.
